(19) United States
(12) Patent Application Publication
(10) Pub. No.: US 2007/0223669 A1
(43) Pub. Date: Sep. 27, 2007

(54) Method and apparatus for alternatively switching between phone service lines

(76) Inventors: Mark T. Bowers, Alpharetta, GA (US); Don Patrick Williams, Harvest, AL (US)

Correspondence Address: Don P. Williams, 4885 Highway 53, Harvest, AL, 35749, US

(21) Appl. No.: 11/699,855

(22) Filed: Jan. 30, 2007

Related U.S. Application Data
(60) Provisional application No. 60/784,159, filed on Mar. 21, 2006.

(51) Int. Cl. H04M 3/42

(52) U.S. Cl. 379/201.01

(57) ABSTRACT

An automatic switching device that alternatively connects the customer's telephony devices via the in-home UTP wiring to the desired telephony service, primary or secondary, upon receiving an incoming call via that service is described. The new device will work reliably with any type of ringing signal provided by the telco, MSO, OTTP, or other service provider. The new device can switch over the entire in-home UTP wiring so that all customer premise equipment connected to the in-home wiring are connected to the desired telephony service no matter the location of the NID, EMTA, PC, ATA or whatever equipment that is providing the service. Furthermore, the new device can either simultaneously disconnect the alternate unused service from the entire in-home wiring or facilitate the use of both services at the same time by implementing call hold feature.

### CROSS-REFERENCE TO RELATED APPLICATIONS

This application is related to and claims priority to U.S. Provisional Patent Application No. 60/784,159, entitled “Method and Apparatus for Alternatively Switching Between Phone Service Lines” filed Mar. 21, 2006, which is incorporated by reference herein.

### FIELD OF THE INVENTION

The present disclosure generally relates to telecommunications equipment. More specifically, the disclosure pertains to devices for switching different types of services to a common wire pair at a customer premise.

### RELATED ART

In telecommunications networks, the subscriber receives a drop line in the form of an unshielded twisted pair (UTP) from the telephone network to a network interface device (NID) on the side of the premise. A wire pair from the NID connects to the customer premise equipment inside the house or business. This type of telephone service delivery has been the preferred method of the Regional Bell operating companies (RBOCs) or independent operating companies (IOCs) for years. In recent times, a new type of telephone delivery service has become commercially available using voice over internet protocol (VOIP). This new VOIP service is being deployed by competitors to the local operating companies, and is typically delivered by cable multiple system operators (MSOs) and over the top providers (OTTPs) such as, for example Vonage and Skype. This new type of telephone service delivery is much different than the local operating companies.

Cable multiple system operators (MSOs) deliver the new type of service, VOIP service, over a coaxial line (Coax) that also provides video and other services to the home. The subscriber receives the new type of service (VOIP) from either a network interface device (NID) mounted on the side of the subscribers premise or from an embedded multimedia terminal adaptor (EMTA) located inside the premise. A wire pair (UTP) from the NID or EMTA device connects to the customer's telephone(s) inside the premise to provide telephone service in much the same way that the local operating companies provide telephony service from the NID to the customer's phones.

Over the top providers (OTTP's) such as Skype deliver VOIP services, another type of telephone delivery service, through a personal computer (PC) that is connected to a broadband network through a cable modem, DSL modem, or wireless service device using for example 802.11, Wimax, or cellular. The subscriber receives telephony services (VOIP) from an analog terminal adaptor (ATA) that is either connected to the computer or directly to the modem and delivers a wire pair (UTP) to the customer's telephone(s) inside the premise.

One of the main problems facing MSOs today is provisioning of the service. Because different types of services are usually provided by two independent competing companies, such as the local telephone company and cable company, it is often difficult to provide an instantaneous cutover from one type of service (telco) to the new type of service (MSO). Both services cannot be enabled at the same time (simultaneously connect both types of services to a common wire pair) because it is possible that damage would occur to customer premise equipment. In addition, such provisioning would violate UL safety regulations. In addition, most customers want to keep their same number so it is unacceptable to wait until their existing service is disabled before the number is ported over to the new type of service. Therefore, the MSO usually must make two truck rolls (for two service calls) to the customer's residence to enable the new type of telephone service. The first service call is to install the new equipment and the second service call is to connect the wire pair providing the new type of service to the common wire pair of the in-home wiring. The wire pair providing the new type of service is connected after the previous type of telephone service has been disconnected. It would be desirable to have a device that would reduce the cost associated with changing from one type of telephone service to another type of telephone service. For some customer it may also be desirable to simultaneously have two types of telephone service and have a device that is capable of switching the common in-home wire pair between the two types of services.

### SUMMARY OF THE DISCLOSURE

Generally, the present disclosure provides a switching device that alternatively connects various types of telephone delivery services to the customer's telephone equipment via the in-home UTP wiring (a common wire pair).

In one embodiment of the disclosure a device receives a first type of service over a first wire pair and a second type of service over a second wire pair. A detector coupled to the second wire pair provides a control signal to a relay for disconnecting a common pair from the first wire pair and connecting the second wire pair to the common pair.

In another embodiment of the disclosure a first type of service on a first wire pair is connected to a first remote switch and a second type of service on a second wire pair is connected to a second remote switch wherein the remote switches monitor activity on a common pair. The first wire pair is connected to the common wire pair if there is no activity on the common wire that would prohibit such a connection.

In a method embodiment of the disclosure a method is disclosed comprising a step of detecting an activity on a first wire pair having a first type of service, monitoring activity on a second wire pair having a second type of service, and selecting one of the pairs to connect to a common pair based on the detecting and monitoring steps.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram of a first embodiment of a disclosure of a switch device.

FIG. 2 is a block diagram of a second embodiment of a disclosure of a switch device.

FIG. 3 is a block diagram of a third embodiment of a disclosure of a switch device.

FIG. 4 is a state diagram illustrating the embodiment of FIG. 3.

FIG. 5 is a state diagram illustrating a fourth embodiment of a switch.

FIG. 6 illustrates a fifth embodiment of the present disclosure.

FIG. 7 illustrates details of the embodiment of FIG. 6.

FIG. 8 illustrates additional details of the embodiment of FIG. 6.

FIG. 9 is a block diagram of remote switches used in the embodiment of FIG. 6.

FIG. 10A and 10B are state diagrams illustrating details of the embodiment of FIG. 6.

FIG. 11 is a state diagram illustrating a sixth embodiment of the disclosure.

FIG. 12 is a state diagram illustrating a seventh embodiment of the disclosure.

FIG. 13 is a state diagram illustrating more details of the embodiment of FIG. 12.

FIG. 14 is a state diagram illustrating an eighth embodiment of the disclosure.

FIG. 15 is a state diagram illustrating more details of the eighth embodiment of the disclosure.

### DETAILED DESCRIPTION

When several types of telephone services are provided at a customer premise, each delivered on a dedicated wire pair, it is often desirable to have each of the types of service available on a common wire pair at the customer premise. The common wire pair is often referred to as the in-house wiring or house wire pair. However, it is unacceptable and often hazardous to have more than one dedicated pair coupled to the common pair at the same time. Hence there is a need for a device or method to selectively connect each type of service to the common pair while the other types of services are disconnected from the common pair. Described herein are embodiments of a disclosed switching device that alternatively connects the customer's telephony devices via the in-home UTP wiring to the desired type of telephone service, primary or secondary, upon receiving an incoming call via that service. The disclosed device functions with any type of ringing signal provided by the telco, MSO, OTTP, or other service provider. Embodiments of the disclosed device switch the in-home wiring, an unshielded twisted pair (UTP) of wires, so that all customer premise equipment connected to the in-home wiring are connected to the desired type of telephone service. In several embodiments interface equipment, such as a NID, an EMTA, a PC, an ATA or whatever equipment that is providing the telephone service may be at dispersed locations. Some embodiments of the disclosed device simultaneously disconnect the alternate unused types of service from the in-home wiring while some embodiments facilitate the use of using two telephone services simultaneously by placing an active call on hold and accepting a new call on the other telephone service line. It is intended that all such embodiments be protected by the claims set forth herein.

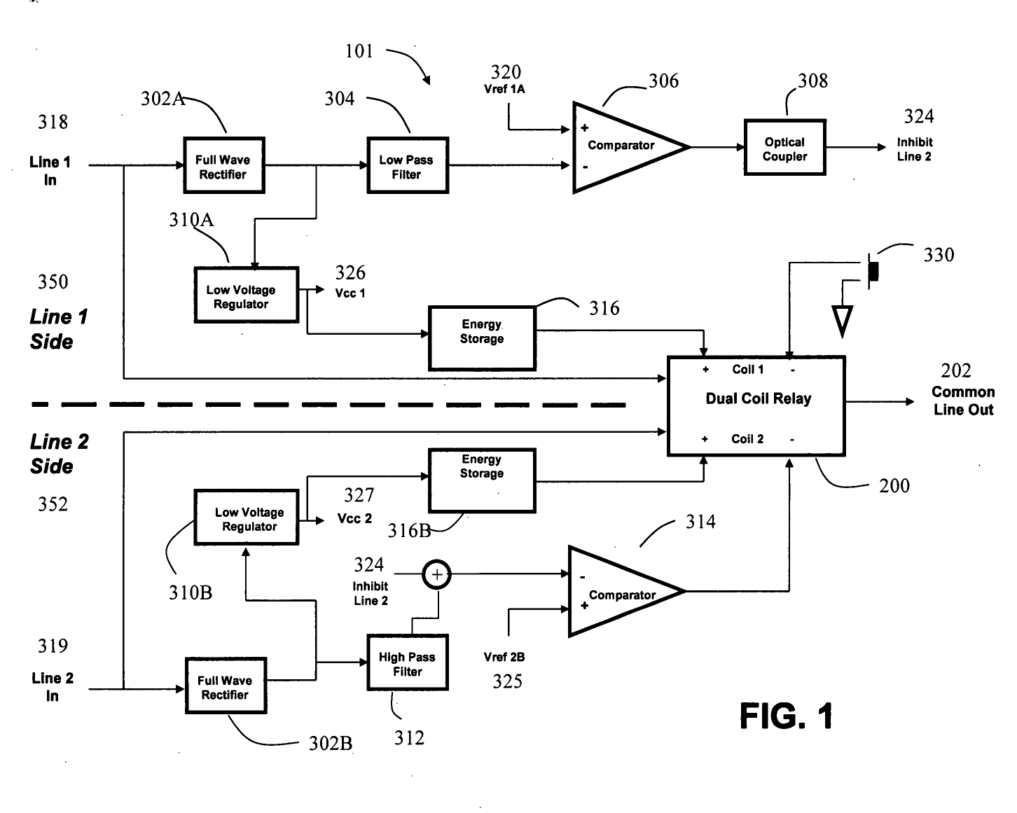

Referring to FIG. 1 there is depicted a block diagram of a first embodiment of switching device 101 of the present disclosure. The switching device 101 is comprised of a dual coil latching relay 200 for switching between either of 2 incoming telephone lines (providing a first type of service and a second type of service) to a common wire pair, Common Line Out 202. The initial position of the relay 200 is such that relay contact connects Line 1 In 318 to the Common Line Out 202. Note that all of the Line 1 Side 350 circuitry is referenced to a local Line 1 ground while all of the Line 2 Side 352 circuitry is referenced to a t local Line 2 ground.

The Line 1 In 318 signal is connected to a full wave rectifier 302A, wherein the rectifier-302A provides a local ground referenced positive voltage output. The output of the rectifier is coupled to the Low Voltage Regulator 310A and the Low Pass Filter 304. The Low Voltage Regulator 310A provides a nominal 5 VDC power supply, referred to as Vcc1 326. Vcc1 326 supplies power to Line 1 circuitry and Energy Storage Device 316. Energy Storage Device 316 preferably is a capacitor but other energy storage may be used. Energy Storage Device 316 is used to power the Coil 1 of the Relay 200. Using the Energy Storage Device 316 allows the relay coil to be driven without any undesirable loading of Line 1 In 318. Switch 330 of switching device 101 is used to manually reset relay 200, i.e. for disconnecting from Line 2 In 319 and connecting to Line 1 In 318.

Low Pass Filter 304 removes the AC portion of the rectified signal and functions as a “hook switch detector”. The Low Pass Filter 304 passes energy below around 20 Hertz and in one embodiment has a pole that is well below the 20 Hz ringing signal used in North America. The output of the Low-Pass Filter 304 is compared to a voltage reference, Vref 1A 320, by the comparator 306. When the difference between Vref and the output of Low-Pass Filter 304 exceeds a threshold then any phone connected to Line 1 is declared to be “off-hook”. The output comparator 306 is coupled to Optical Coupler 308 (for optical isolation). The output of Optical Coupler 308 is then forwarded to signal Inhibit Line 2 324. Line 2 Comparator 314 prevents relay 200 from switching to Line 2 to common line 202 when Line 1 is “off-hook”.

When a signal is on The Line 2 In 319 full wave rectifier 302B provides a local ground referenced positive voltage output. The output of the full wave rectifier 302B is sent to Low Voltage Regulator 310B and the High-Pass Filter 312. The Low Voltage Regulator 310B provides a nominal 5 VDC power supply, referred to as Vcc2 327, to supply power to Line 2 circuitry. In addition Vcc2 327 voltage is sent to the Energy Storage Device 316B, typically a capacitor, but another storage device may be used in other embodiments. Energy Storage Device 316B is used to power the Coil 2 of the Relay 200. Using the Energy Storage Device 316B allows the relay coil (coil 2) to be driven without loading Line 2 In 319.

When a high-voltage ringing signal is on Line 2 In, High Pass Filter 312 passes signal to the comparator 314. The output of the High Pass Filter 312 is compared to a voltage reference Vref 2B 325 to detect when a valid ringing voltage is present on Line 2 In 319. When a valid ringing voltage is present on Line 2 In 319 Comparator 314 sends a signal to Relay 200 causing Common Line Out 202 to connect to Line 2 In 319.

To summarize, the Common Line Out 202 is initially connected to Line 1 In 318. When a ringing signal is detected on Line 2 In 319 the Common Line Out 202 will switch to Line 2 In 319, unless Line 1 In 318 is “off-hook”. When Low-Pass Filter 304 detect Line 1 In is “off-hook” an inhibit signal coupled to Inhibit Line 2 324 prevents the Relay 200 from being switched. In the first embodiment, as shown in FIG. 1, relay 200 switches from Line 2 In 319 to Line 1 In 318 when manual reset switch 330 is pushed.

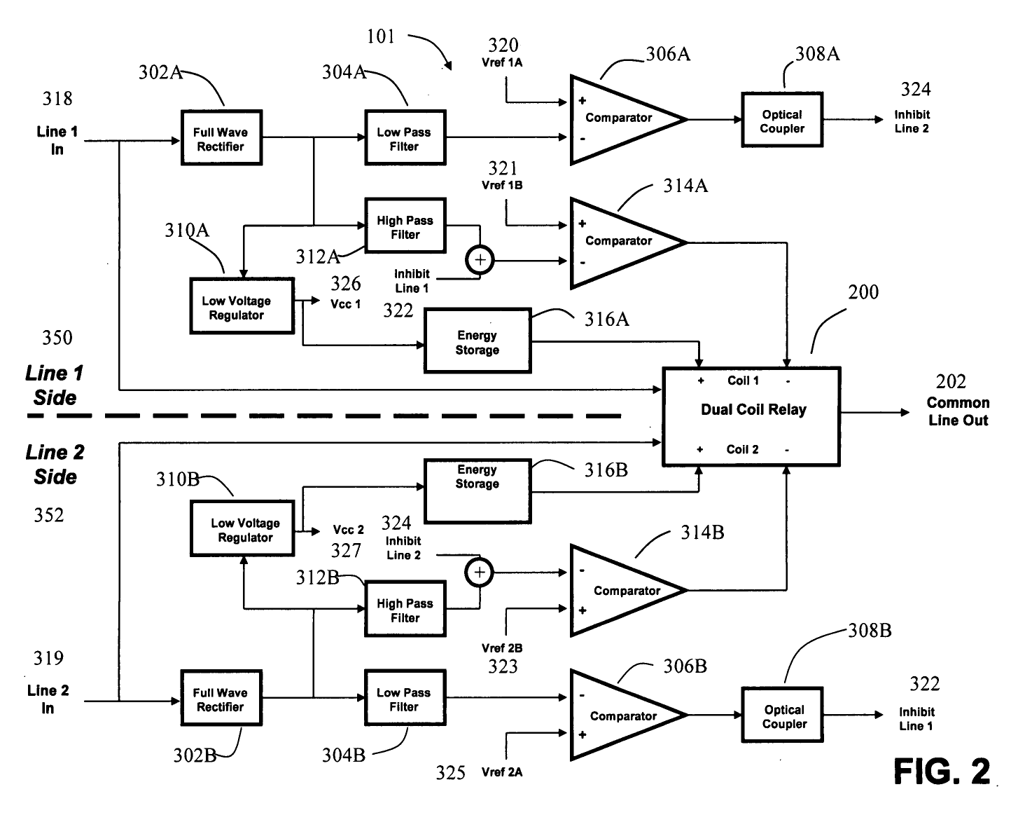

Referring to FIG. 2 there is seen a block diagram of a second embodiment of the disclosure. The second embodiment is a direct extension of the first embodiment and many elements are identical. The primary difference is that the circuits coupled to Line 1 Side 350 and Line 2 Side 352 are identical. Dual coil latching relay 200 is used to switch between a first type of service connected to Line 1 In 318 and a second type of service connected to Line 2 In 319. Because the circuits for Line 1 and Line 2 are identical only the Line 1 circuits are described. Note that all of the Line 1 circuitry is referenced to a local Line 1 ground while all of the Line 2 circuitry is referenced to a different local Line 2 ground. Comparator 314A provides a signal for coil 1 Relay 200 when a ringing signal is detected on Lin 1 In 318. An Energy Storage Device 316A (typically a capacitor) is used to provide the current required for energizing the coil 1 of the Relay 200.

A signal on Line 1 In 318 signal is passed through a full wave rectifier 302A to provide a local ground referenced positive voltage output. The signal is sent to Low Pass Filter 304A, the High Pass Filter 312A, and the Low Voltage Regulator 310A. The Low Voltage Regulator 310A provides a nominal 5 VDC power supply, referred to as Vcc1, to the rest of the Line 1 circuitry. The Vcc1 voltage is sent to the Energy Storage Device 316A, typically a capacitor, which is used to power the Coil 1 of the Relay 200.

The Low-Pass Filter 304A removes the AC portion of the rectified signal and is used for a “hook switch detector”. The Low Pass Filter 304A has a pole that is well below the 20 Hz ringing signal used in North America. The signal coming out of the Low-Pass Filter 304A is compared to a voltage reference, Vref 1A 320, by the comparator 306A and outputs a signal that indicates when the phone connected to Line 1 is “off-hook”. This signal is optically isolated by the Optical Coupler 308A and presented as the signal Inhibit Line 2 324. This signal is summed into the Line 2 Comparator 314B to prevent the relay from switching over to Line 2 when Line 1 is “off-hook”.

The High Pass Filter 312A passes any high voltage ringing signal to the comparator 314A. The output of the High Pass Filter 312A is compared to a voltage reference Vref 1B 321 to detect when a valid ringing voltage is present on Line 1. When a valid ringing voltage is detected on Line 1, Comparator 314A provides a signal to the Relay 200 for switching Common Line Out 202 to Line 1 In 318.

To summarize, the Common Line Out 202 will be connected to either Line 1 In 318 or to Line 2 In 319 by the Relay 200. When a ringing signal is detected on either line, the Common Line Out 202 switches to that line having the ringing signal unless the other line is already “off-hook”. In that case an inhibit function prevents the Relay 200 from switching to the ringing line.

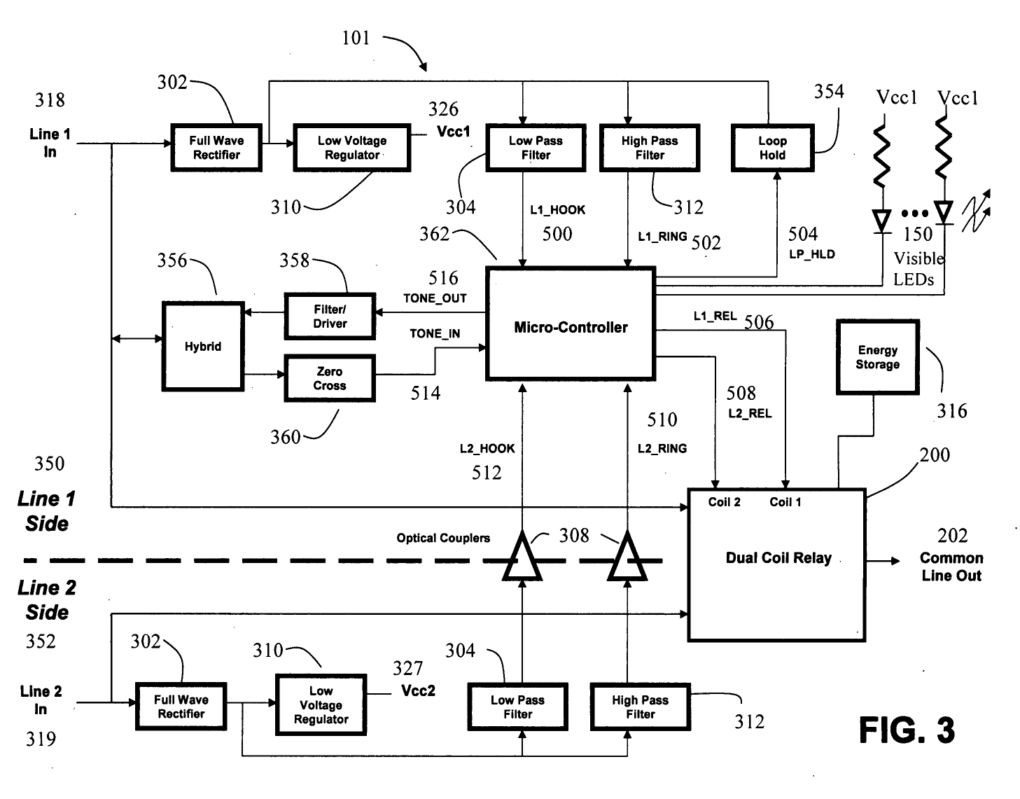

Referring to FIG. 3 there is block diagram of a third embodiment of the disclosure. The third embodiment is used in when a subscriber has two phone services delivered on two separate telephone lines, a primary line with a first type of service and a secondary line with a second type of service. The primary line is typically used for the majority of the telephone connections and is used for all outgoing calls. The secondary line may be any type of service, but is an intercom line for this exemplary embodiment. Only incoming calls are accepted on the secondary line for this embodiment, but one important distinction is that the incoming calls can be accepted even if the primary line is in use (off hook). The primary service is provided over a first pair of wires and the secondary service is provided over a second pair of wires. Each of the wire pairs may be connected to common wire pair that is connected to phone equipment as will be seen. This arrangement is usually an artifact of a subscriber transferring their voice service from the incumbent telephone provider to an alternative voice provider, a cable company for example. In high density housing complexes there is very often a central intercom system that is used to monitor and control entry into the building. This intercom system utilizes the same pair of wires that enter the subscriber residence that the incumbent telephone provider uses. When a subscriber transfers phone service to an alternative provider, the pair of wires connected to the intercom system is usually disconnected and therefore the intercom system no longer works. The third embodiment provides a technique for allowing the subscriber to continue to use their existing intercom system even though the incumbent telephone provider has been disconnected.

Referring to FIG. 3 the “primary line” and “secondary line” described above are shown as Line 1 In 318 and Line 2 In 319 respectively. A dual coil latching relay 200 is used to switch the Common Line Out 202 between Line 1 In 318 and Line 2 In 319. The Full Wave Rectifier 302, Low Voltage Regulator 310, Low-Pass Filter 304, High-Pass Filter 312, and Energy Storage 316 blocks perform the identical function that they did in Embodiment 2 so they are not described again here. In this case the Energy Storage Device 316 powers both coils of Relay 200. Note that the Line 1 Side 350 is electrically isolated from the Line 2 side 352 by the Optical Couplers 308 and the Relay 200.

A Micro-Controller 362 functions as a controller for the third embodiment and drives the 2 coils of the relay 200. The Low-Pass Filters 304 provide signals to the Micro-Controller 362 indicating the hook status of Line 1 In 318 and Line 2 In 319. The High-Pass Filters 312 provide signals to the Micro-Controller 362 indicating if ringing is present on either Line 1 In 318 or Line 2 In 319. The Loop Hold 354 circuit is used to simulate an off-hook condition on Line 1 In 318 when activated by the Micro-Controller 362. Approximately 20 mA of current will flow through the Loop Hold 354 when activated. A Hybrid 356 circuit is used to couple AC signals to and from Line 1 In 318 and the Micro-Controller 362. The Hybrid 356 circuit is constructed from resistors and capacitors although other embodiments are possible. Signals that are sent from the Micro-Controller 362 are passed through the Filter/Driver circuit 358 and coupled to Line 1 In 318 by the Hybrid 356. The Filter/Driver 358 provides some wave shaping to the digital signals coming from the Micro-Controller 362 and also lowers the output impedance. Signals that are sent from Line 1 In 318 to the Micro-Controller 362 pass through the Hybrid 356 and a Zero Cross 360 circuit. The Zero Cross 360 circuit converts an analog AC signal from Line 1 In 318 into a 1 bit digital signal that can be processed by the Micro-Controller 362. Firmware in the Micro-Controller 362 provide the logic and processing for detecting single or multiple tones coming from the Zero Cross 360. In one embodiment a discrete Fourier transform provides the processing function in the Micro-Controller 362. Visible LED indicators 150 provide line status, however other line status indicators, auditory for example, could be used.

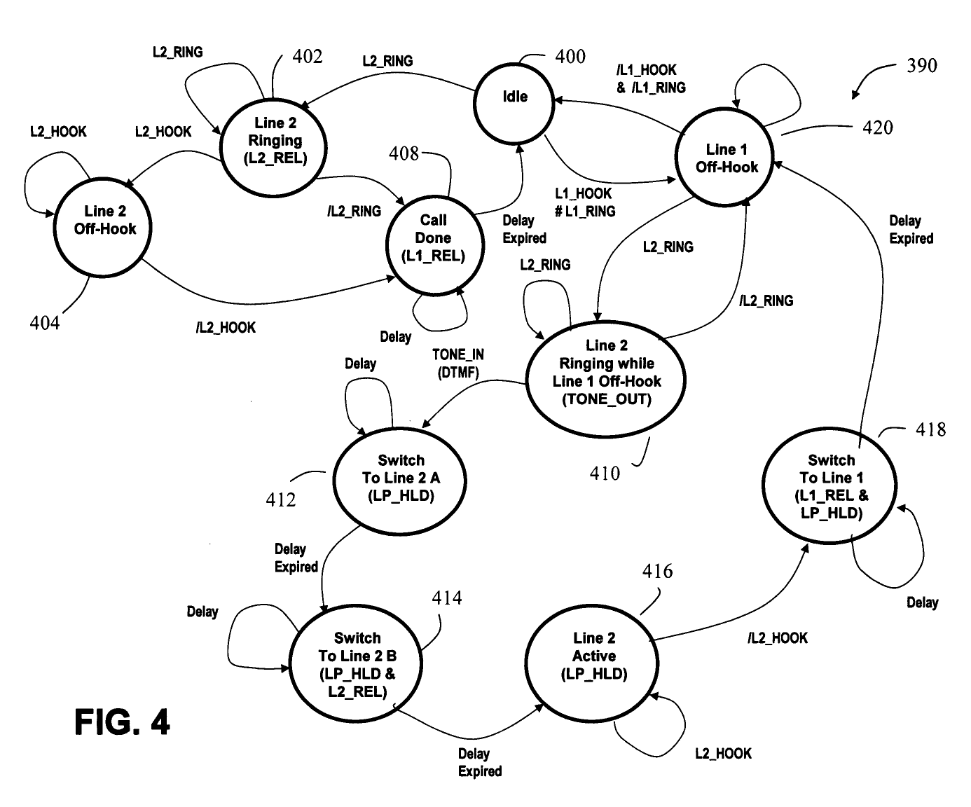

The third embodiment is best understood by referring to the state diagram 390 shown in FIG. 4. State diagram 390 shows the information flow provided by the logic of the firmware contained in the Micro-Controller 362. The starting state is the Idle state 400, when both Line 1 In 318 and Line 2 In 319 are in the “on-hook” state. Relay 200 is in the default position wherein the common line is connected to Line 1 In 318. If Line 2 In 319 rings, the L2_RING 510 signal will be active and logic provided by the firmware causes a transition to the Line 2 Ringing 402 state and activates the L2_REL 508 signal. This causes the relay 200 to switch to Line 2 In 319 and a phone connected to Common Line Out 202 will start ringing. If the phone is not answered then the firmware will transition to the Call Done state 506 and activate the L1_REL signal 506 causing the relay 200 to switch back to Line 1 In 318. The firmware will then transition back to the Idle state 400. From state Line 2 Ringing 402 if the call is answered the firmware will transition to the Line 2 Off-Hook state 404. The firmware will remain in this state until the phone goes back on-hook causing the firmware to transition to the Call Done state 408.

From the Idle state 400, if Line 1 In 318 goes off-hook, or rings, the firmware transitions to the Line 1 Off Hook state 420. If the ringing phone is not answered or the off-hook phone is placed back on-hook then the firmware transitions back to the Idle state 400. From the Line 1 Off-Hook state 420, if Line 2 In 319 rings the firmware moves to the Line 2 Ringing while Line 1 Off-Hook state 516. In this state the TONE_OUT signal 516 is sent which provides an audible tone to the user. The user has the option of ignoring the incoming call on Line 2 In 319 or answering it. In one embodiment f the user chooses to answer Line 2 In 319 call, a press of the appropriate key (e.g. the “#” key) on the phone will send a DTMF tone pair causing the DTMF_IN 514 signal to activate (note: a flash hook or similar method could also be used in place of said DTMF signal). The firmware will transition to the Switch to Line 2 A state 412 which will activate the LP_HLD signal 504. After a short delay the firmware will transition to the Switch to Line 2 B state 414 which will activate both the L_H signal 504 and the L2_REL signal 508. This will cause the relay to switch over to Line 2 In 319. The firmware will then transition to the Line 2 Active state 416 which will activate only the LP_HLD signal 504. In this state the user can communicate with the caller on Line 2 In 319 while the call on Line 1 In 318 is being held. Many intercom systems require the user to press one or more DTMF digits to gain entry into an apartment or the like. In one embodiment when the user is done communicating on Line 2 In 319 a “flash-hook” will cause the signal L2_HOOK 512 to deactivate (note: a DTMF or similar signal could also be used in place of flash hook). The firmware will then transition to the Switch to Line 1 state 418 which will activate both the L1_REL signal 506 and the LP_HLD signal 504. This causes the Relay 200 to switch back to Line 1 In 318. After a short delay the firmware will transition to the Line 1 Off-Hook state 420 which will deactivate the LP_HLD signal 504. The user can then continue communicating on Line 1 In 318. When the user hangs up the firmware will transition back to the Idle state 400.

To summarize, the Common Line Out 202 will normally be connected to Line 1 In 318 by the Relay 200. When a ringing signal is detected on Line 2 In 319 the Common Line Out 202 will automatically be switched to that line, unless Line 1 In 318 is already off hook. In that case a tone will be sent to the user to notify the user that there is an incoming call on Line 2 In 319. The user can optionally place the Line 1 In 318 call on hold and switch to Line 2 In 319 by pressing a DTMF digit.

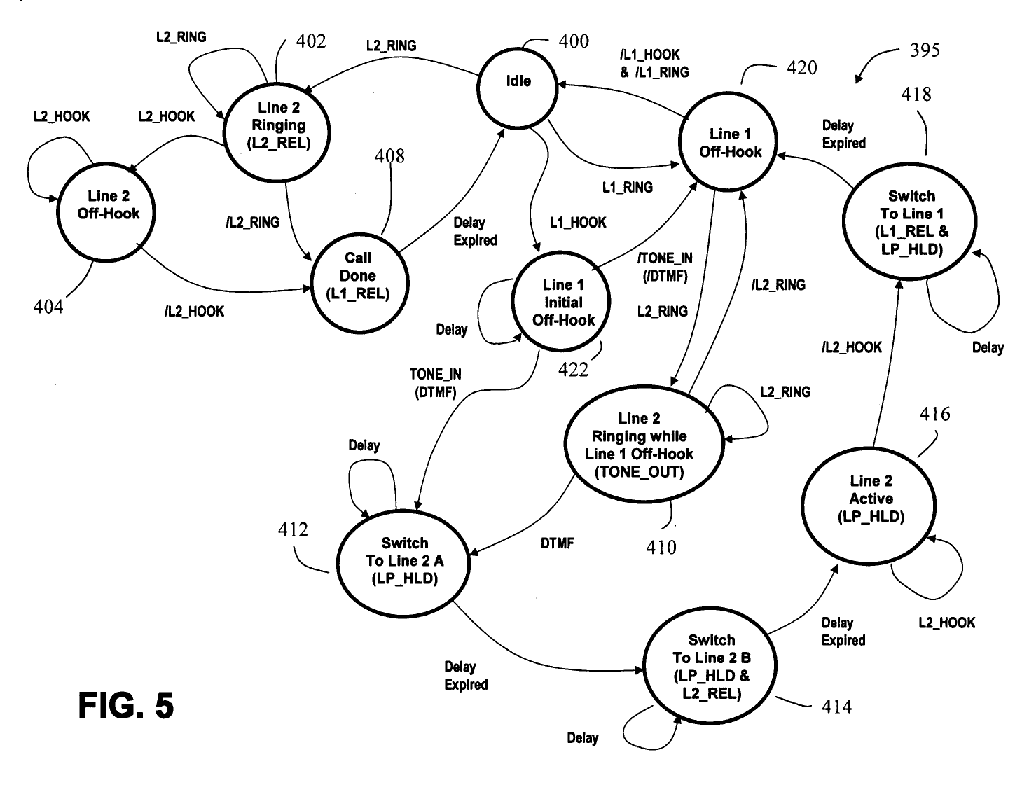

A fourth embodiment has most of the features of the third embodiment but with an added feature of being able to select line 1 or line 2 for out going calls. The hardware is identical to the third embodiment and is shown in FIG. 3. The firmware is almost identical to third embodiment and the difference are shown in state diagram 395 shown in FIG. 5. Note that there is a single added state shown as Line 1 Initial Off-Hook 422. When a phone connected to Line 1 In 318 is initially taken off-hook the firmware will transition from the Idle state 400 to the Line 1 Initial Off-Hook state 422. A delay will allow the user to optionally press a DTMF digit on their phone to select Line 2 In 319 for the outgoing call. For example, a “#” key within the first 3 seconds of taking the phone off-hook would select Line 2 In 319. If the DTMF digit is detected within this delay period the firmware will transition to the Switch to Line 2 A state 412. If the DTMF digit is not detected within this delay period the firmware will transition to the Line 1 Off-Hook state 420. Everything else in the firmware for Embodiment 4 is identical to Embodiment 5

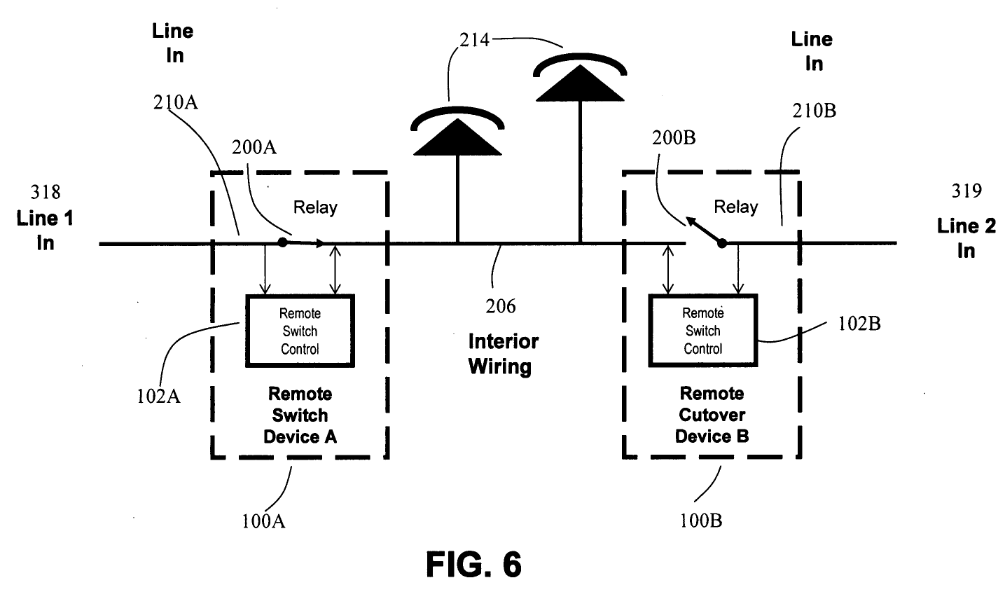

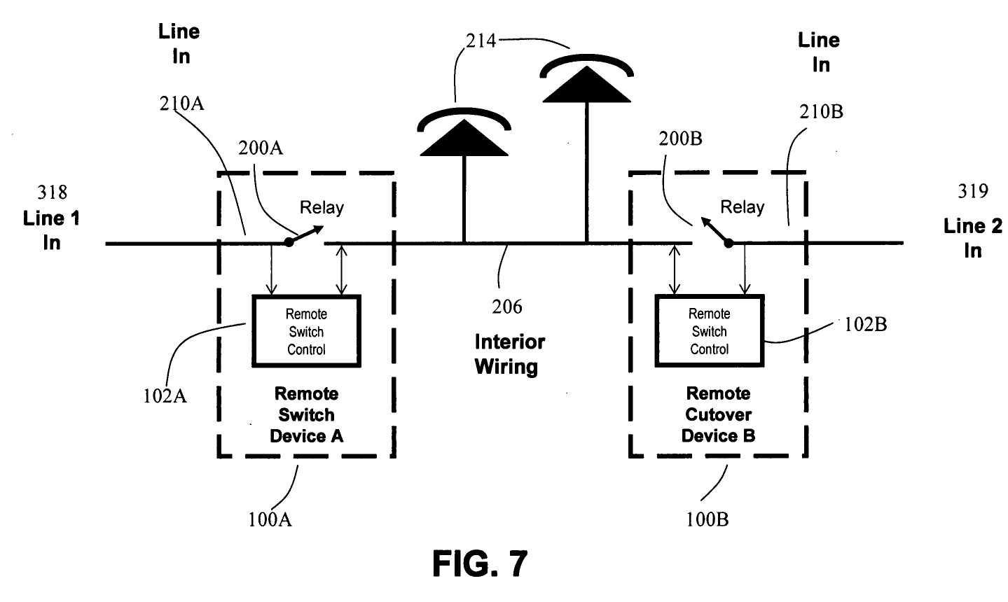

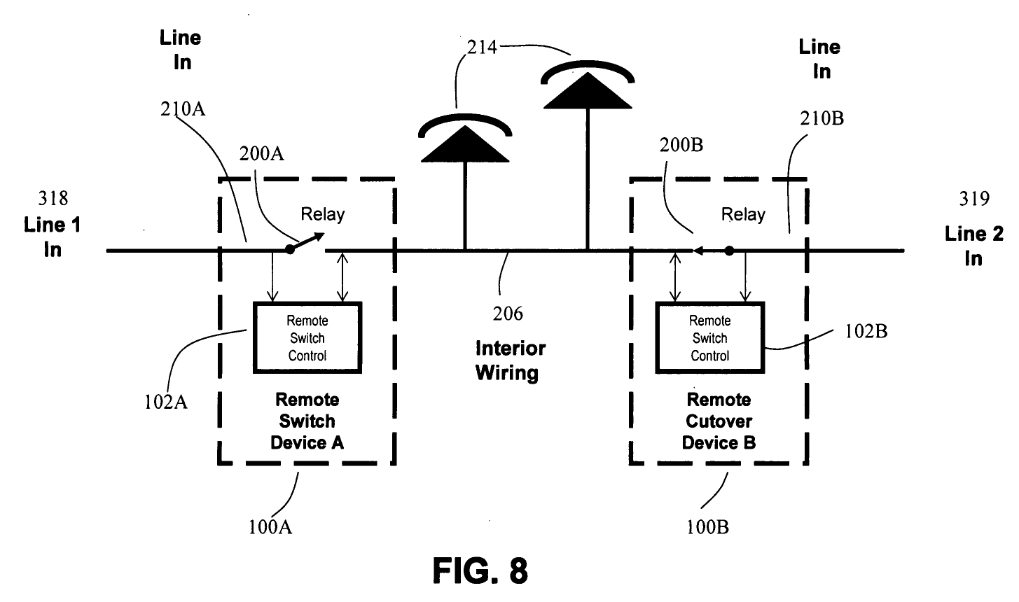

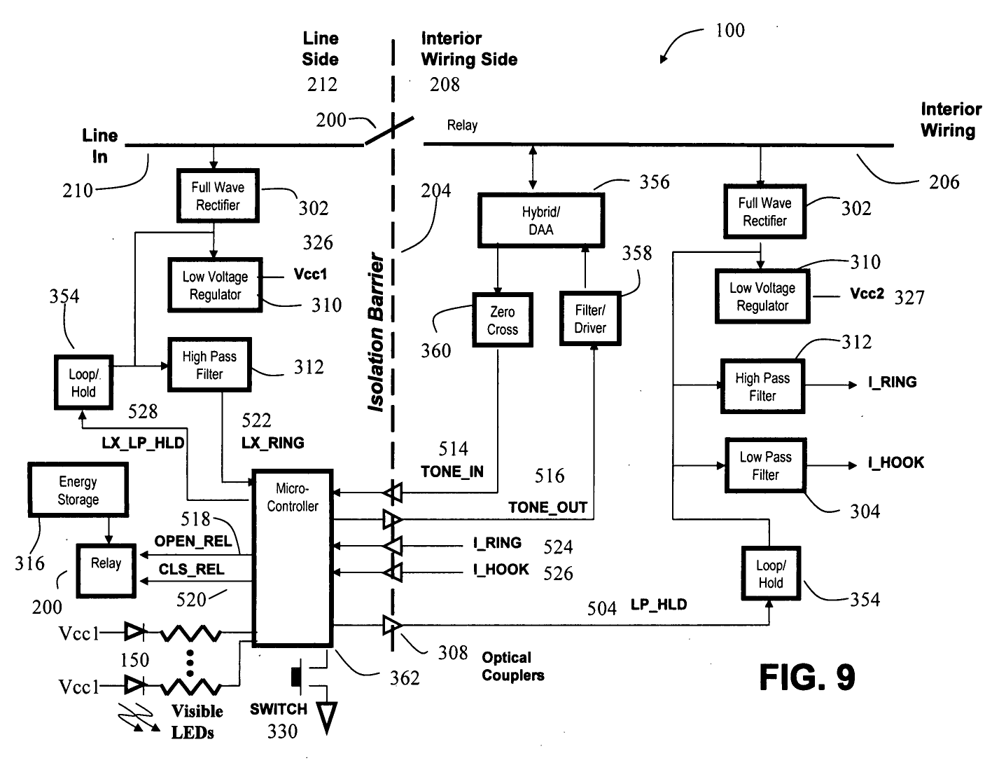

To summarize, the Common Line Out 202 will normally be connected to Line 1 In 318 by the Relay 200. When the user takes the phone off-hook they can optionally switch to Line 2 In 319 by pressing a DTMF digit within a predetermined amount of time. If they don't press that digit then the outgoing call will be placed on Line 1 In 318. When a ringing signal is detected on Line 2 In 319 the Common Line Out 202 will automatically be switched to that line, unless Line 1 In 318 is already off hook. In that case a tone will be sent to the user to notify the user that there is an incoming call on Line 2 In 319. The user can optionally place the Line 1 In 318 call on hold and, switch to Line 2 In 319 by pressing a DTMF digit.

Wherein the first four embodiments of the disclosure have a single enclosure for coupling the first wire pair or the second wire pair to a common wire pair other embodiments use distributed remote switch devices as will be as is shown in FIG. 6-8. Variations of embodiments of the disclosure using remote switch devices are described as embodiments 5, 6, 7, and 8. Embodiments of the disclosure using remote switch devices have advantage in that the switching function is broken up into multiple devices that can be placed in different locations. For example one device can be placed outside a residence at the demarcation point and another device can be placed inside the residence at a VoIP device. The remote switch devices communicate with each other to coordinate opening and closing of relays. In addition, no special wiring is required. Embodiments 5, 6, 7, , and 8 all use the hardware as shown in FIG. 9, and provide functions corresponding to different firmware programming. An exemplary embodiment of a system having remote switching devices and that form the basis for embodiments 5, 6, 7, and 8 is best understood by referring to FIG. 6, FIG. 7, and FIG. 8.

In FIG. 6 there are 2 incoming telephone lines referred to as Line 1 In 318 and Line 2 In 319. These 2 lines are connected to Line In 210A and Line In 210B of Remote Switch A 100A and Remote Switch B 100B respectively. The Interior Wiring 206 of both Remote Switches are connected together and represent the telephone wiring present inside a typical structure. Also connected to the Interior Wiring 206 are 1 or more phones or other customer premise equipment. This is collectively referred to as CPE 214. In FIG. 6 Relay 200A, a part of Remote Switch A 100A, is in the closed position connecting Line 1 In 318 to the Interior Wiring 206. Relay 200B is in the open position disconnecting Line 2 In 319.

The switch over process starts when Remote Switch Control 102B goes off hook, using the Loop Hold 354, and sends a tone sequence on the Interior Wiring 206. This may be in response to a ringing signal being applied to Line 2 In 319 or some other stimulus. The tone sequence is received by Remote Switch Control 102A which in turn opens Relay 200A as shown in FIG. 7. In this state both Relays 200A and 200B are in the open position so that Line 1 In 318 and Line 2 IN 319 are isolated (not connected to) the Interior Wiring 206. Remote Switch Control 102B senses that nothing is driving the Interior Wiring 206 and closes Relay 200B in response, as shown in FIG. 8. This completes the switch-over process.

Embodiment 5 allows switching between 2 lines once and requires a manual reset to switch back. Referring to FIG. 9, a dual-coil latching relay 200 is used to open or close the connection from the line card to the interior house wiring in response to signaling coming from a similar device at the other end. All of the elements shown in FIG. 9 are identical to those from FIG. 3, they are simply connected in a slightly different way. For the purposes of understanding, the Line Side 212 and Interior Wiring Side 208 from FIG. 9 correspond to the Line 1 Side 350 and Line 2 Side 352 respectively from FIG. 3. In the case of FIG. 9 there is no Common Line Out 202 since the relay 200 is either opened or closed. Note that the Hybrid 356, the Zero Cross 360, and the Filter/Driver 358 have been moved to the other side of the Isolation Barrier 204. This requires the addition of several Optical Couplers 308 to pass the signals TONE_IN 514, TONE_OUT 516, and LP_HOLD 504 across the Isolation Barrier 204. Note also the addition of a second Loop/Hold circuit 354 to the Line Side 212 of the Isolation Barrier 204. This second Loop/Hold 354 allows a call on Line In 210 to be put on hold when a second call comes in from another device connected to the Interior Wiring 206. The Switch 330 is added as an input to the Micro-Controller 362 for manual resetting. In one embodiment visible LED indicators 150 provide line status, however other line status indicators, auditory for example, could be used.

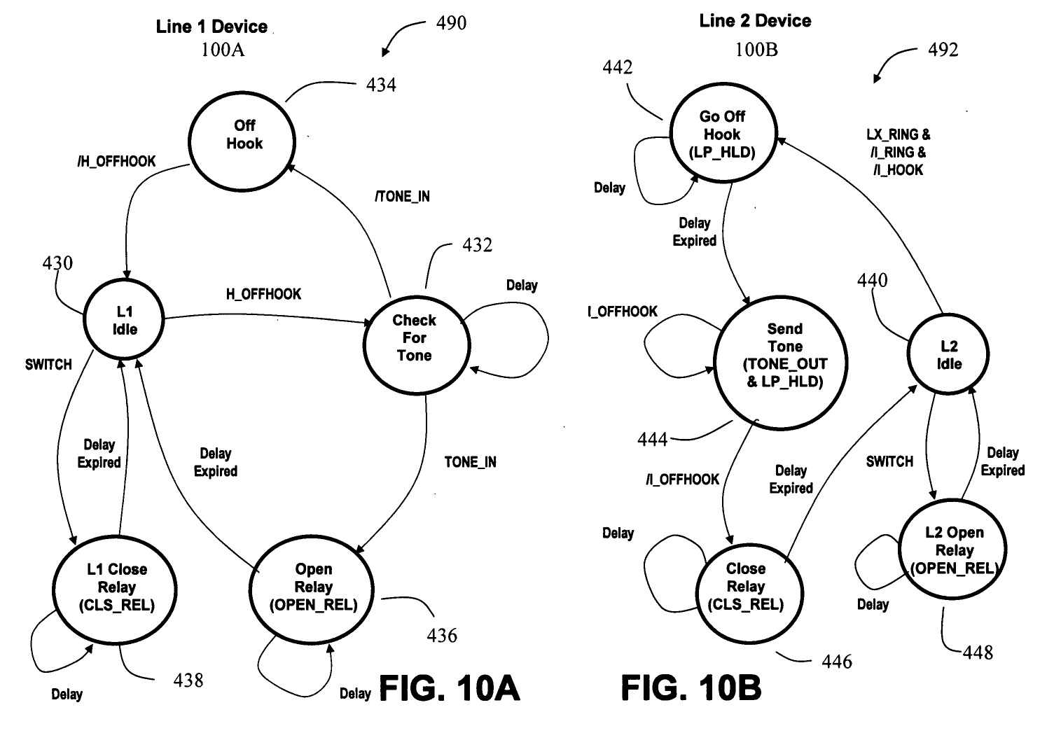

Operation of Embodiment 5 is best understood by viewing state diagram 490 of FIG. 10A. In this embodiment there are 2 devices required that are differentiated by different firmware loads. One device is physically connected to Line 1 In 318 and another is connected to Line 2 In 319. The firmware control of the Line 1 device and Line 2 devices are shown in FIG. 10.

The Line 1 device 100A starts out in the L1 Idle State 430. If the Switch 330 is pressed the firmware will transition to the Close Relay state 438 which will send the signal CLS_REL and close the Relay 200. The firmware will then transition back to the L1 Idle State 430. From the L1 Idle State 430, an off-hook on the Interior Wiring 206 will cause the H_OFFHOOK signal to be active and the firmware will transition to the Check for Tone state 432. If the TONE_IN signal 514 is detected within a predetermined delay (e.g. a few seconds) then the firmware will transition to the Open Relay state 436 and the signal OPEN_REL 518 will be sent causing the relay 200 to open. The firmware will then transition back to the L1 Idle state 430. At this point, only a manual push of the Switch 330 will close the relay 200 (note: relay will not close until there is no activity detected on the in-home common wire pair). If from the Check for Tone state 432 the TONE_IN is not detected the firmware will transition to the Off Hook state 434. When the phone goes back on hook the firmware will transition to the L1 Idle state 430.

The Line 2 device 100B starts out in the L2 Idle State 440. If the Switch 330 is pressed the firmware will transition to the Open Relay state 448 which will send the signal OPEN_REL 518 and open the relay 200. The firmware will then go back to the L2 Idle state 440. If ringing is present on the Line In 210 the LX_RING signal 522 will be active. If the Interior Wiring 206 is neither off-hook nor ringing then the firmware will transition to the Go Off Hook state 442 and activate the LP_HLD signal 504. The firmware will then transition to the Send Tone state 444 and send both the LP_HLD signal 504 and the TONE_OUT signal 516. This effectively takes the Interior Wiring 206 off-hook and sends a tone to the far end Line 1 Device 100A. The firmware waits until the I_HOOK signal 526 goes inactive which is an indication that the Line 1 Device 100A has opened its relay. The firmware then transitions to the Close Relay state 446 and sends the signal CLS_REL 520 which closes the Relay 200. This completes the switchover from Line 1 In 318 to Line 2 In 319.

To summarize, Embodiment 5 allows for remote switching of 2 incoming lines onto a common line, typically the interior wiring of a structure. Two devices are required, one connected to each of the 2 incoming lines. Once the switchover has occurred a manual reset of each device is required to return to the default configuration.

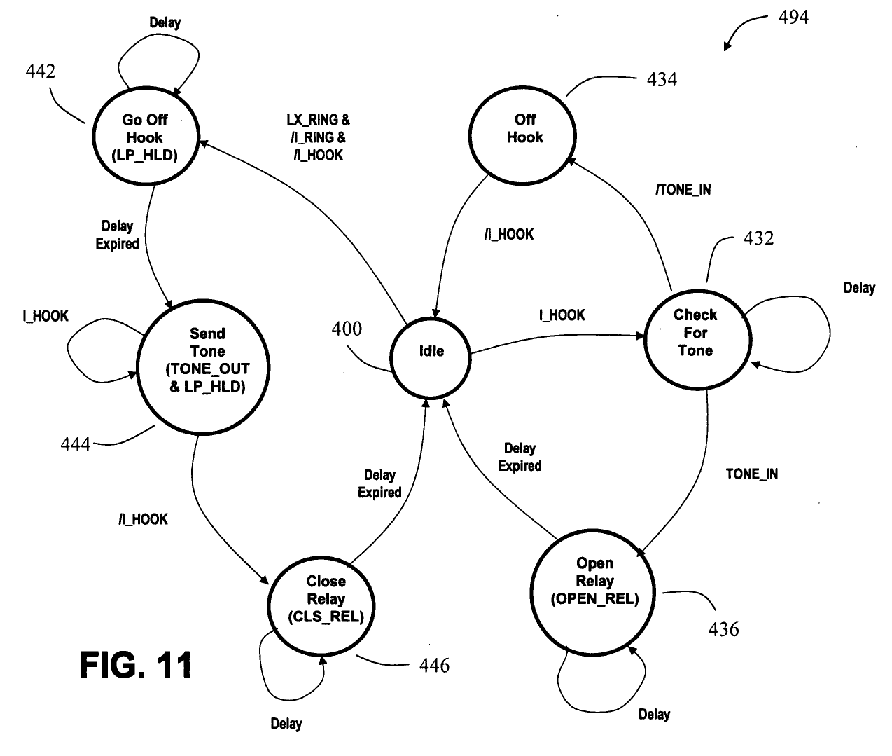

Embodiment 6 is a direct extension of Embodiment 5. In this case the 2 devices, Line 1 Device 100A and Line 2 Device 100B, are identical in all aspects to each other. There is no differentiation between Line 1 and Line 2. In functionality Embodiment 6 is equivalent to Embodiment 2, the difference being that Embodiment 6 splits the functionality into 2 separate units. The hardware is shown in FIG. 9 and is identical to Embodiment 5. Referring to FIG. 11, the firmware essentially combines the 2 state diagrams from FIG. 10 into a single one. Note that states L1 Idle 430 and L2 Idle 440 from FIG. 10 are combined into a single Idle state 400. There is no push button reset in Embodiment 6 so the states L1 Close Relay and L2 Open Relay have been eliminated. All other states and functionality is essentially the same for Embodiment 6 as it was for Embodiment 5.

To summarize, Embodiment 6 allows for the remote switching of 2 incoming lines onto a common line, typically the interior wiring of a structure. Two devices are required, one connected to each of the 2 incoming lines. A ringing signal on either of the 2 incoming lines will cause the interior wiring to be switched automatically be switched to that line, unless the other line is already “off-hook”. In that case an inhibit function will prevent the interior line from being switched.

Embodiment 7 is a direct extension of Embodiments 5 and 6. In this case there can be 2 or more devices, one of which will serve as the “primary” device. The “primary” device will be connected to the “primary” line, while multiple “secondary” devices can be connected to multiple “secondary” lines. The hardware for Embodiment 7 is identical to Embodiments 5 and 6 but the firmware is different. Embodiment 7 allows the user to select which of multiple lines to use for outgoing calls.

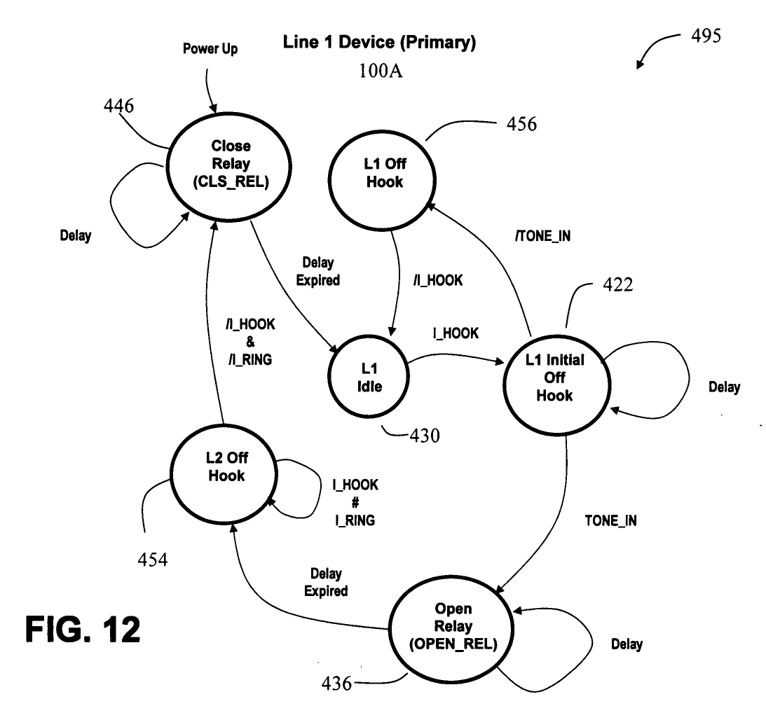

FIG. 12 shows the state diagram of the firmware contained within the Line 1 Device 100A which serves as the “primary” line device. The firmware powers up in the Close Relay state 446 which sends the signal CLS_REL 520 closing the Relay 200. The firmware then transitions to the L1 Idle state 430. If Line 1 goes off hook, the firmware will transition to the L1 Initial Off Hook state 422. The user can optionally press a DTMF digit on the phone to switch over to Line 2. This DTMF digit will be received by the Line 2 Device 100B which will send a tone sequence back to the Line 1 Device 1 00A as described below. If the TONE_IN signal 514 is received by the Line 1 Device 100A then the firmware will transition to the Open Relay state 436 and send the OPEN_REL signal 518 opening the relay 200. The firmware will then transition to the L2 Off Hook state 454 and wait for Line 2 to go back on hook. While in the L2 Off Hook state 454 if the I_HOOK 526 and I_RING 524 signals are both inactive the firmware will transition to the Close Relay state 446 sending the CLS_REL signal 520 closing the Relay 200. The firmware will then transition to the L1 Idle state 430. While in the L1 Initial Off Hook state 422 the TONE_IN signal 514 is not received, the firmware will transition to the L1 Off Hook state 456. When the I_HOOK signal 526 goes inactive the firmware transitions back to the L1 Idle state 430.

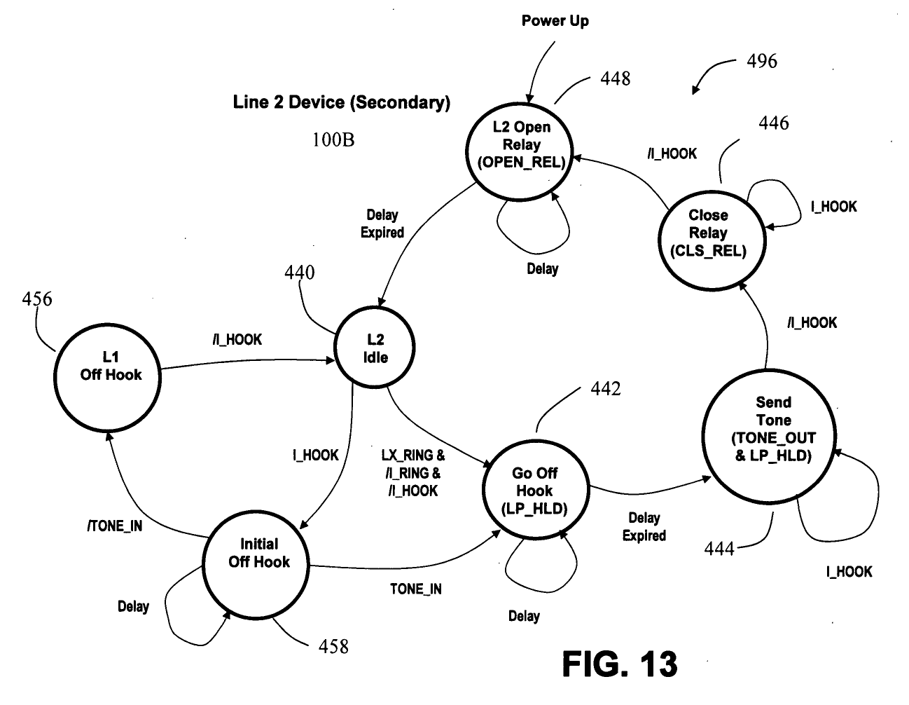

FIG. 13 shows the state diagram of the firmware contained within the Line 2 Device 100B which serves as the “secondary” line device. The firmware powers up in the Open Relay state 448, which sends the signal OPEN_REL 518 opening the Relay 200. The firmware then transitions to the L2 Idle state 440. If the I_HOOK signal 526 is received the firmware will transition to the Initial Off Hook state 458 and look for a DTMF signal from the user. If the DTMF signal is received within a predetermined amount of time (a few seconds) the TONE_IN will go active and the firmware will transition to the Go Off Hook state 442 and send the LP_HLD signal 504. This will activate the Loop/Hold circuit 354 taking the Interior Wiring 206 off hook. The firmware will then transition to the Send Tone state 444 and send the signal TONE_OUT 516 which will be received by the Line 1 Device 100A. The Line 1 Device 100A should open its Relay 200A which will cause the signal I_HOOK 526 to go inactive. The firmware will then transition to the Close Relay state 446 sending the signal CLS_REL 520 causing the Line 2 Relay 200B to close. The firmware will remain in the Close Relay state 446 until the Interior Wiring 206 goes back on hook indicated by the I_HOOK signal 526 going inactive. This will cause the firmware to transition back to the Open Relay state 448 sending the signal OPEN_REL 518 causing the Relay 200B to open. The firmware will then transition back to the L2 Idle state 440.

From the L2 Idle state 440, if a ringing signal is present on Line 2 In 319 the LX_RING signal 522 will go active. If neither I _RING 524 nor I_HOOK 526 is present the firmware will transition to the Go Off Hook state 442 and send the LP_HLD signal 504. This will cause the switch over from Line 1 In 318 to Line 2 In 319 for the duration of the phone call.

To summarize, Embodiment 7 allows for the remote switching of 2 incoming lines onto a common line, typically the interior wiring of a structure. Two devices are required, one connected to each of the 2 incoming lines. The interior wiring is initially switched to the “primary” line in. A ringing signal on the “secondary” line will cause the interior wiring to be switched automatically to that line, unless the “primary” line is already “off-hook”. In that case an inhibit function will prevent the interior line from being switched. When a user goes off hook the interior wiring will initially be switched to the “primary” line. If the user wishes to place a call on the “secondary” line, a push of the appropriate DTMF digit will cause a switch over to the secondary line for the duration of the call. Note that multiple “secondary” lines could be implemented by using multiple “secondary” devices. Each of these “secondary” devices would have to be differentiated from each other so that they respond to a unique DTMF sequence. This could be implemented in a variety of ways to those skilled in the art.

Embodiment 8 is a direct extension of Embodiment 7 and adds call-holding capability. When a call is present on Line 1 and another call comes in on Line 2, the user can optionally put the Line 1 call on hold and switch over to Line 2. When the Line 2 call completes, the devices will automatically switch back to the Line 1 call.

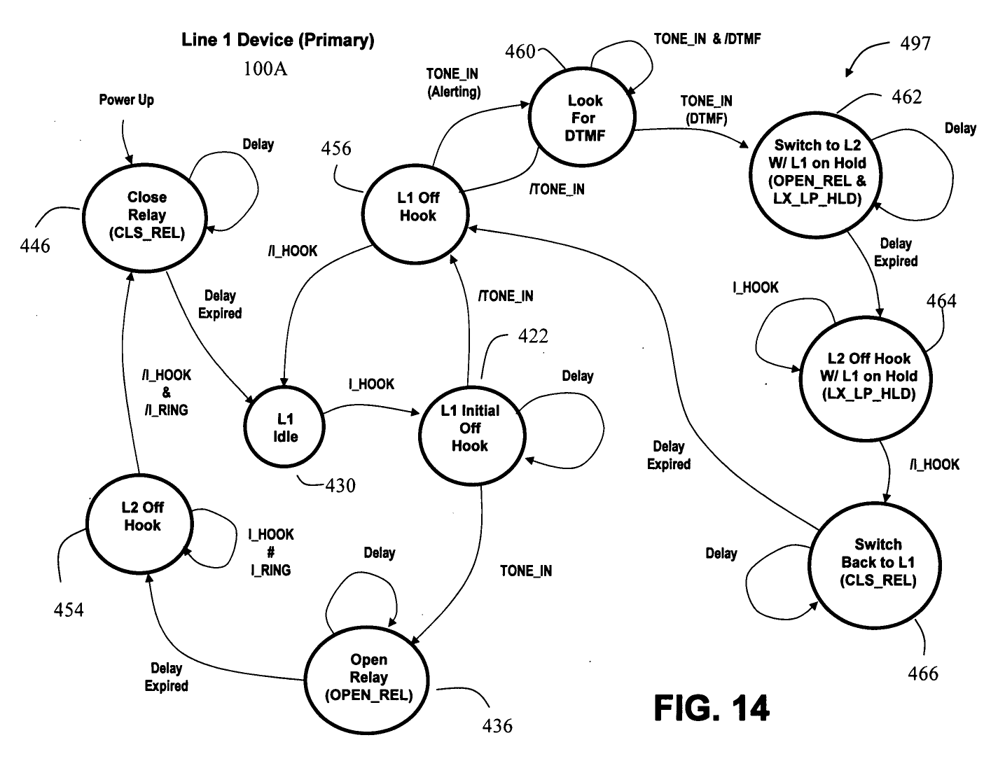

FIG. 14 shows the state diagram for the firmware contained within the Line 1 Device of Embodiment 8. Note that this diagram is identical to FIG. 12 with the following exceptions. Embodiment 8 has several states added to allow for an incoming call on Line 2 while Line 1 is off hook. From the L1 Off Hook state 456, if the proper tone or tone sequence, as indicated by the TONE_IN signal 514, is received the firmware will transition to the Look for DTMF state 460. This is an indication that a call is coming in on Line 2 and the Line 2 Device 100B is sending the alerting tone to the user. If the user presses the appropriate DTMF digit on their phone this will be received as TONE_IN 514 and the firmware will transition to the Switch to L2 w/ L1 on Hold state 462. This state will drive both the OPEN_REL signal 518 and the LX_LP_HLD signal 528 which will put the Line 1 call on hold and open the relay 200A. The firmware will then transition to the L2 Off Hook w/ L1 on Hold state 464 which will send only the LX_LP_HLD signal 528. When the Line 2 call completes the I_HOOK signal 526 will go inactive and the firmware will transition to the Switch Back to L1 state 466 and send the CLS_REL signal. This process switches the call back to Line 1 and the firmware will transition back to the L1 Off Hook state 456.

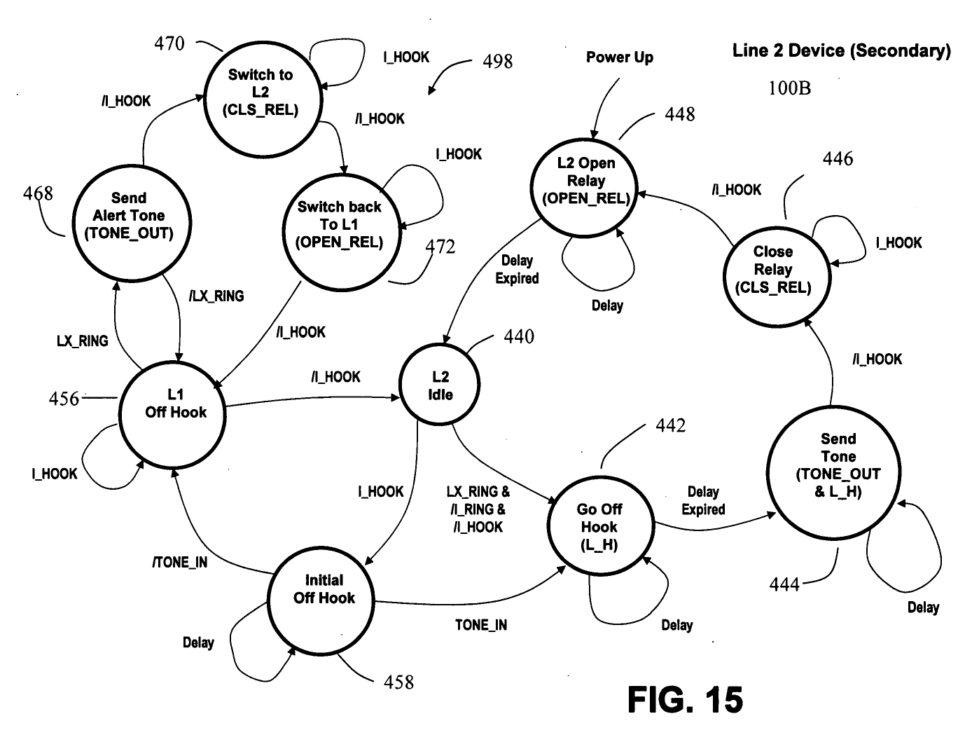

FIG. 15 shows the state diagram of the firmware contained within the Line 2 Device 100B of Embodiment 8. Note that this diagram is identical to FIG. 14 with the following exceptions. Embodiment 8 has several states added to allow for an incoming call on Line 2 while Line 1 is off hook. From the L1 Off Hook state 456, if a ringing signal is present on Line In 210 the firmware will transition to the Send Alert Tone state 468 and drive an audible tone out the line using the signal TONE_OUT 516. This will be heard by the user on Line 1 and is an indication that there is a call pending on Line 2. The user can optionally press a DTMF digit to accept the call on Line 2, placing the Line 1 call on hold. If the call is accepted the Line 2 device will open up the relay 200 and the signal I_HOOK 526 will go inactive. In response, the firmware will transition to the Switch to L2 state 470 and send the CLS_REL signal 520 causing the relay 200B to close. When the call on Line 2 completes the I_HOOK signal 526 will go inactive causing the firmware to transition to the Switch Back to L1 state 472 sending the OPEN_REL signal 518 causing the relay 200B to open. The firmware will then transition back to the L1 Off Hook state 456.

To summarize, Embodiment 8 adds the call-holding functionality to Embodiment 7. If a call comes in on Line 2 while a call is taking place on Line 1 an audible alerting tone is sent to the user by the Line 2 device. Receiving the alerting tone by the Line 1 device prepares it to look for the proper DTMF digit from the user. If the user presses the proper DTMF digit while the alerting tone is present the call on Line 1 is placed on hold, the Line 1 relay 200A is opened, and the Line 2 relay 200B is closed. When the call on Line 2 is over, the Line 2 relay 200B is opened and the Line 1 relay 200A is closed. The Line 1 call is taken off hold and the user can continue the Line 1 call.

It should be further emphasized that the above-described embodiments of the present invention are merely possible examples of implementations and set forth for a clear understanding of the principles of the invention. Many variations, modifications, and combinations may be made to the above-described embodiments of the invention without departing substantially from the spirit and principles of the invention. All such modifications, combinations, and variations are intended to be included herein within the scope of this disclosure and the present invention and protected by the following claims.

Now, therefore, the following is claimed:

1. An apparatus for coupling a first type of telephone service on a first wire pair or a second type of telephone service on a second wire pair to a common wire pair, the apparatus comprising:
a relay having a first port coupled to the first wire pair and a second port coupled to the second wire pair, wherein the relay is initially latched for coupling the first wire pair to the common wire pair;
a detector for detecting activity on the second wire pair, the detector providing a control signal to the relay in response to detecting an activity indicative of a call request; and
an energy source for supplying power for switching the relay in response to the control signal thereby coupling the second wire pair to the common wire pair.

2. The apparatus of claim 1 wherein activity on the first wire pair inhibits the relay from coupling the second wire pair to the common wire pair.

3. The apparatus of claim 1 wherein the common wire pair is coupled to the first wire pair in response to a reset signal.

4. The apparatus of claim 1 wherein a hold circuit simulator is coupled to the first wire pair for allowing the first type of service to remain on line when the common pair is coupled to the second wire pair.

5. The apparatus of claim 1 wherein the first type of service is conventional phone service and the second type of service is voice over the internet service.

6. The apparatus of claim 1 wherein energy sources in the apparatus are line powered.

7. The apparatus of claim 1 further having a detector for detecting activity on the first wire pair, the detector providing a control signal to the relay to couple the first wire pair to the common wire pair.

8. The apparatus of claim 1 further adding a control circuit enabling the ability to manually select either the first type of phone service line or the second type of phone service line for placing outgoing call.

9. A method for coupling either a first type of service on a first wire pair or a second type of service on a second wire pair to a common wire pair, the method comprising:
coupling the first type service to the common wire pair through a latching relay;
detecting a connection request on the second type of service and generating a control signal in response to the request; and
sending energy from an energy source to the latching relay in response to the control signal thereby disconnecting the first wire pair from the common pair and connecting the second wire pair to the common wire pair.

10. The method of claim 9 further comprising the step of inhibiting the connection of the second wire pair to the common wire pair when an inhibit signal is provided by an off-hook detector monitoring the first wire pair.

11. The method of claim 9 wherein the energy source receives energy from a second wire pair that delivers the second type of service.

12. A remote switch for connecting a first type of service on a first wire pair to a common wire pair, the remote switch comprising;
a first detector connected to the first wire pair wherein the first detector determines if a valid request for connection signal is on the first wire pair;
a second detector connected to the common wire pair wherein the second detector determines if the common pair has activity that prohibits establishing a new connection;
a controller that generates a control signal in response to information from the first detector and the second detector; and
a relay that closes when the control signal indicates a valid request and no prohibiting activity is on the common pair, thereby connecting the first wire pair to the common wire pair.

13. The remote switch of claim 12 further having a DTMF detector circuit.

14. The remote switch of claim 12 wherein common wire pair is further coupled to a second remote switch for coupling a second wire pair to the common wire pair.

15. The remote switch of claim 12 further having one or more line status indicator(s).

16. The remote switch of claim 12 wherein a loop hold circuit is coupled to the first wire pair thereby enabling the first type of service to placed on hold.

17. A method for coupling one of multiple service types, where each service type has a corresponding wire pair, to a common wire pair, the method comprising;
detecting when one of the service types requests a connection;
determining if the common wire pair is available for connecting to the type of service requesting a connection; and
connecting the service type requesting a connection to the common wire pair when the common wire pair is available.

18. The method of claim 17 further comprising the step of sending a tone to the common wire pair before completing the connecting step.

19. The method of claim 17 further comprising disconnecting the service type from the common wire pair when an on hook condition occurs.

20. The method of claim 17 where the detecting step comprises;
rectifying a signal;
filtering the rectified signal with a high-pass filter; and
determining if the energy in the filter signals exceed a threshold value.
